(19) United States
(12) Patent Application Publication
(10) Pub. No.: US 2024/0102508 A1
(43) Pub. Date: Mar. 28, 2024

(54) WASHER FOR COVERING SLOTS

(71) Applicant: Siemens Mobility GmbH, München (DE)

(72) Inventors: Sebastian Bleth, München (DE); Jörg Melde, Olching (DE); Jörg Pforr, Moosach (DE)

(21) Appl. No.: 18/263,752

(22) PCT Filed: Dec. 13, 2021
(86) PCT No.: PCT/EP2021/085461

§ 371 Date: Aug. 1, 2023

(30) Foreign Application Priority Data
Feb. 1, 2021 (DE) 10 2021 200 853.4

(51) Int. Cl. F16B 43/00

(52) U.S. Cl. CPC F16B 43/00

(57) ABSTRACT

A washer for covering a slot has a washer body and a bore in the washer body. The bore is arranged asymmetrically in the washer body in relation to a rotation on the washer body about its center point. There is also described a method for covering oblong holes with such a washer and to a mounting assembly, in particular a metal structure, in which a slot has been covered by way of such a washer.

The invention relates to a washer for covering slots, in particular to an asymmetrical, elongate or oval disk for (completely) covering slots. Moreover, the invention relates to a method for covering slots with such a washer, and to an assembly module, in particular a metal construction, in which slots have been covered by means of such a method.

Slots are often used for compensating tolerances in assembly modules. In the case of screw connections or rivet connections this offers the advantage that workpieces require less precise manufacturing, or deformations arising in the construction e.g. due to heat can be compensated for.

However, depending on the length of the slot, the issue may arise that this slot cannot be completely covered by standard washers. This not only represents a visual flaw but moreover has the technical disadvantage that an increased contact pressure per unit area may occur.

Symmetrically embodied special disks have to be relatively large in order to completely cover a long slot, and therefore require a correspondingly large installation space. In this way, a customary standard washer according to ISO 7089 (external diameter is approx. double the screw diameter) can only cover relatively short slots of which the length is not more than 1.5 times the width. Considering a standard washer according to ISO 7093 (external diameter is approx. three times the screw diameter), the slot should thus not be longer than twice its width.

Up to now, correspondingly large slots either have not been completely covered, or very large disks with a correspondingly large space requirement have been used.

It is an object of the present invention to specify an alternative, more comfortable washer and a method for using such a washer, by way of which the disadvantages described above can be avoided.

This object is achieved by a washer as claimed in patent claim 1, by a method as claimed in patent claim 8, and by an assembly module as claimed in patent claim 10.

A washer according to the invention for covering slots comprises a disk body and a bore in the disk body, wherein the bore is disposed in the disk body so as to be asymmetrical in terms of a rotation on the disk body about the center of the latter. This means that the center of the bore lies beside the center of the washer. In the case of a round bore, the latter is thus disposed eccentrically on the washer, in the case of the bore being a slot the center of the slot lies beside the center of the washer. The center of the washer can readily lie in the region of the bore (simply not in the center of the latter). The asymmetry is of course not microscopically minute but exceeds any production tolerance.

A method according to the invention for covering a slot in a component by means of a washer according to the invention comprises the following steps:
placing the washer over the slot and introducing a cylindrical fastening element (preferably a screw or a rivet) through the bore of the washer and through the slot.

The fastening element here can first be pushed through the washer and this group can then be positioned over the slot, or the washer can be placed onto the slot and the fastening element can be pushed through the bore and the slot.
aligning the fastening element in the slot in a predetermined fastening position.

This fastening position depends on the type of construction which this slot serves. In the case of construction, the fastening element will be situated at a location of the slot that is defined by the construction, or by the parts to be connected, respectively. Therefore, there exists a “predetermined fastening position”.
aligning the washer in an overlapping position in which the slot is covered across the full area, where in the washer, if an overlap with the slot is not possible in one alignment, for this purpose is rotated by 180° about the fastening element.

The washer is now moved above the slot such that the slot is covered across the full area. This can also be performed in that the washer is simply rotated by 180° about the fastening element (thus about the surface normal of the slot). If the washer has a slot as a bore, a displacement of the washer along this long bore can also additionally take place.
fastening the fastening element so that the washer is clamped in the overlapping position above the slot.

The fastening element with the washer is now fastened in an orderly manner, thus screwed in the case of a screw, and riveted in the case of a rivet.

The bore of the washer here is preferably a slot, and additionally a further, in particular round, supplementary washer is preferably placed over the bore of the washer so that the bore of the washer is covered across the full area.

In terms of the method it is to be noted that the overlap of the slot is an important aspect of the invention. Typically however, two construction elements are joined, wherein one of these construction elements has the slot. In the case of this method it is thus to be implied that, using the fastening element, a further component is additionally fastened to that component in which the slot is situated. The further component usually has a round hole which can be covered with a simple round (supplementary) washer according to the prior art. Should the further component also have a slot, it is of course possible for the method proposed here to be carried out with a washer according to the invention on each side of the connection, thus to position a first washer over the first slot and a second washer over the second slot, corresponding to the position of the respective slot, so that both slots are covered across the full area. In this instance, the construction in the cross section would be as follows: first washer, first component with the first slot, second component with a second slot, second washer.

It is obvious that the method cannot be applied to slots with excessively large dimensions and washers with excessively small dimensions. It is also obvious that each hole can be covered by any washer as long as the latter is of a sufficient size. In practice, however, most slots can be readily covered with a minimum space requirement using a matching washer according to the invention.

An assembly module according to the invention is preferably a metal construction, particularly preferably a rail vehicle, e.g. a locomotive or a railroad car. The assembly module comprises at least one washer according to the invention, wherein at least two washers are particularly preferable, specifically at least one on each side of a slot. This washer here preferably covers one slot of the assembly module, preferably across the full area. Said washer can in particular have been attached by means of a method according to the invention, which in practice can be noticed in that the washers have orientations according to their position above the slot. In comparison to the prior art, such an assembly module has the advantage that, apart from a complete closure of a slot and thus protection against environmental influences, a better mechanical strength is also guaranteed, because the pressure of a fastening element can be directed onto the entire periphery of a slot.

Further particularly advantageous design embodiments and refinements of the invention are derived from the dependent claims and from the description hereunder, wherein the claims of one claim category can also be refined in a manner analogous to the claims and descriptive parts pertaining to another claim category, and individual features of different exemplary embodiments or variants can in particular also be combined so as to form new exemplary embodiments or variants, respectively.

According to one preferred embodiment, the bore of the washer is shaped as a slot. The slot has a length a and a width b, where a>b. It is preferable here for the slot to have semicircular end regions, but said slot can theoretically also be rectangular (optionally with radiused corners). The ratio of length a to width b is particularly preferably a/b≤2, in particular a/b≤1.5. It is preferable for the slot to be disposed in a mirror-symmetrical manner in the washer, preferably on the longitudinal axis of the latter.

The width of the bore in the washer should correspond to the width of the slot to be covered, and/or correspond to the diameter of the fastening element which is to serve for fastening (i.e. somewhat larger so that the fastening element can be inserted through the bore). The slot to be covered is indeed not part of the invention, but the dimensions thereof are known and a washer having the matching size has simply to be used.

As opposed to a purely round bore, a slot as a bore in the washer permits the washer above a slot in a component to be displaced along the shank of a screw or of a rivet. This results in more effective positioning being possible than in the case of a purely round bore, and the washer can be of a smaller and thus more space-saving design.

In order for the bore (in the form of a slot) to be able to be covered in a simple manner by a round (supplementary) washer, the length a of said slot should not be more than twice the width (thus the diameter of the bore). In this way, covering is possible using standard round (supplementary) washers according to ISO 7093 at each position of a fastening element in the bore. If a standard round (supplementary) washer according to ISO 7089 is to be used, the length should not be more than 3/2 of the width.

According to one preferred embodiment, the washer is shaped to elongate such that the length L of the washer is greater than the width B of the latter. In this way, said washer can be produced in a manner which saves more material than a round (supplementary) washer and can cover a slot in a more space-saving manner. In this context it should be noted that for effectively covering a slot with the width y, a maximum peripheral thickness of y of the washer is required on each side of the slot (cf. ISO 7093 for the round case), and often a peripheral thickness of y/2 (cf. ISO 7089 for the round case). Considering a washer with the length L and the width B, preferably L>1.5B, or preferably L<3B. The higher dimension here is mentioned only because most slots are not excessively long and in practice almost all normal slots can be covered in the preferred range of the dimensions of the washer.

According to one preferred embodiment, the bore of the washer lies substantially on one half of the washer. The term “substantially” herein means that more than 70%, in particular more than 80%, of the area of the bore (e.g. of a slot) lies on one half of the washer. It is how ever preferable that part of the area of the bore can readily protrude into the other side of the washer. However, it is preferable that the bore is positioned in the washer such that the center (or rather: the penetration point of the central longitudinal axis) of a screw matching the bore, in each position in the bore, lies beyond the center on that side of the washer on which the largest area of the bore is situated. The bore in terms of the longitudinal axis thereof thus preferably does not protrude into the other half by more than half the width of the bore. For a slot with semicircular end regions with the radius b/2, for example, this means that the bore embodied as a slot protrudes into the other half of the washer by not more than b/2 (preferably less). With a bore disposed in such a way, a washer can be designed so as to be very small in relation to a slot in a component, and nevertheless cover the entire slot, because the washer can be rotated by 180° above the slot so as to effectively cover the slot in each position of a screw in the latter, as has been mentioned above in the context of the method.

According to one preferred embodiment, the longitudinal axis of the bore with the length a (the bore again having the width b) lies on the longitudinal axis of the washer with the length L. In the case of an elongate washer this means that the bore is disposed so as to be mirror-symmetrical to the longitudinal axis. As a result of the asymmetrical disposal of the bore (in terms of the center of the washer; thus the rotational-symmetrical asymmetry as required above) the washer on the one side of the bore has a shorter peripheral thickness with the length d, and on the opposite side of the bore has a longer peripheral thickness with the length c, on this longitudinal axis. It preferably applies here that c>1.5d. This means that if a round bore is sized such that the latter has the width 2d (the thinner periphery of the washer thus being at least half the bore diameter, similar to an ISO 7089 disk, which would lead to c>3d), the bore in this instance would protrude beyond the center of the washer by less than half, e.g. by a quarter of the diameter of said bore). A bore which would be designed as a slot with the length a=c and the width b=2d, would protrude beyond half the washer by b/2.

According to one preferred embodiment which proceeds from a preceding disposal of the bore and the variables a, b (length and width of the bore) and c, d (width of the peripheries of the washer), the inner periphery of the bore that faces the longer peripheral thickness c, has a spacing of more than 0.4 (d−b) and/or less than 0.6 (d−b), preferably of (d−b)/2, from the center of the washer. This means that the periphery of the bore can readily protrude into the other half (if b>d) but the entire bore may also lie beyond the centerline of the washer (if d>b). For most slots, b>d is preferable because this results in a very compact construction mode of the washer and very many slots can readily be covered therewith.

According to one preferred embodiment, which proceeds from a preceding disposal of the bore and the variables a, b (length and width of the bore) and c, d (width of the peripheries of the washer), the following applies for the length c of the longer peripheral thickness: c≥a−b+2d. This leads to a preferred washer with a length L (L=a+c+d if the bore lies on the longitudinal axis), which is of a very advantageous design and can cover many slots with a minimal input of material (given a suitable width of the washer).

With an elongate washer having an asymmetrical embodiment (in terms of rotation) with a relatively short slot as the bore (e.g. able to be completely covered by a disk according to ISO 7089 or ISO 7093), complete covering of slots in each tolerance-related position is possible. The size of the washer and thus the space requirement of the latter can be reduced to a minimum here. The installed position of the disk can be varied by rotation or displacement, depending on the requirement.

However, it is to be noted yet again in this context that a corresponding size of the washer should be chosen in the case of excessively long slots. In general, in the case of a bore with the length a and the width b, the peripheral thicknesses on the longitudinal axis (lengths c and d) should be chosen such that c>2d (or better c>a−b+2d). For covering a slot of the length x, d>x/2−a+b and c>x−a+b should be chosen.

One advantage of the invention is therefore that a slot in each tolerance-related position can be completely covered, and the dimensions of the disk can nevertheless be reduced to a minimum. This improves the contact pressure per unit area as well as the visual appeal.

The invention will be explained in more detail yet again hereunder with reference to the appended figures and by means of exemplary embodiments. The same components are provided with identical reference signs in the various figures. The figures are typically not true to scale. In the figures:

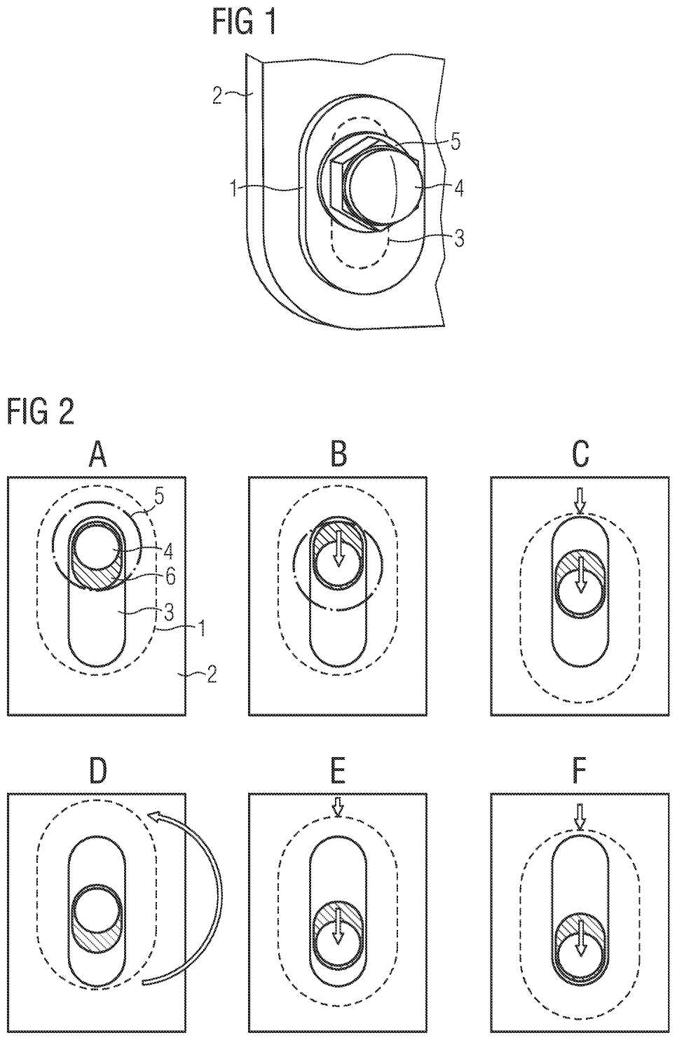

FIG. 1 shows a preferred washer which covers a slot, in a perspective view from above;

FIG. 2 shows a plurality of positions of a preferred washer above a slot;

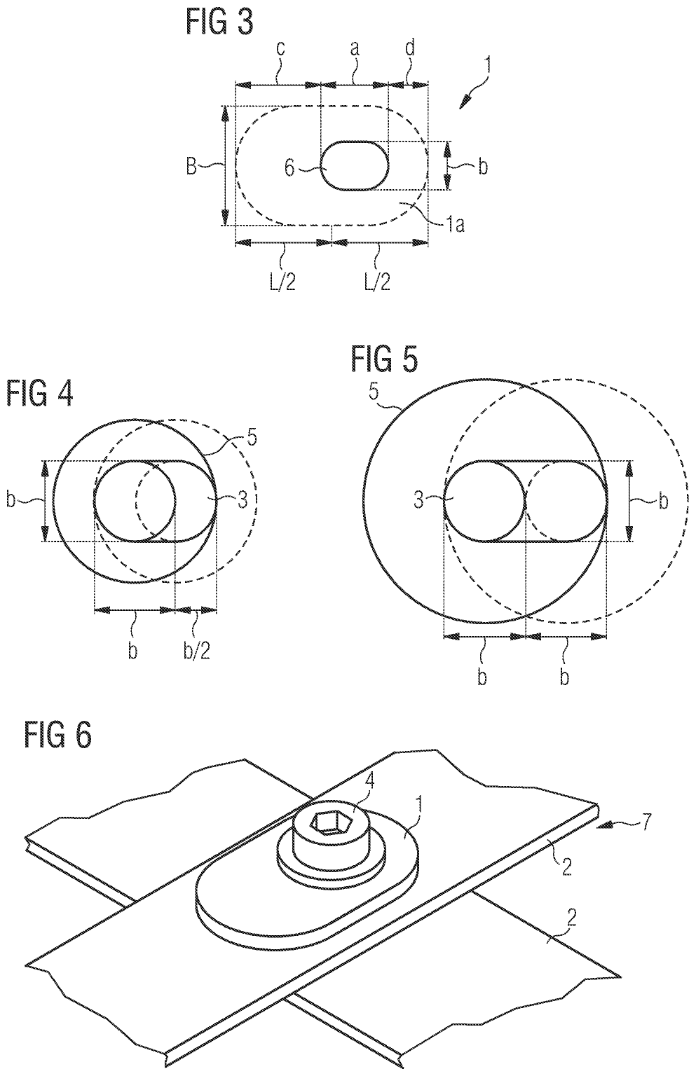

FIG. 3 shows the dimensions of a preferred washer;

FIG. 4 and FIG. 5 show the coverage of a short slot with round washers according to the prior art; and

FIG. 6 shows an example of a simple assembly module in a perspective view.

FIG. 1 shows a perspective illustration of a preferred washer 1 according to the invention, which covers a slot 3 in a component 2. The slot 3 here is covered across the full area and is therefore indicated by dashed lines. While it is obvious that typically two components 2 are to be connected to one another by means of the screw 4, which herein is plotted as the fastening element 4, only one component 2 is plotted here (the other may also be simply obscured as a result of the perspective view). Only the screw 4, the preferred washer 1, a normal round supplementary washer 5 and the component 2 can be seen in the perspective view from above.

FIG. 2 shows a plurality of positions of a preferred washer 1 above a slot 3, such as said washer 1 could be positioned by means of the method according to the invention, for example. The view now is from the other side than illustrated in FIG. 1, thus viewed from a component 2. To be seen are the shank of the screw 4 and the slot 3. The washer 1 here is partially obscured by the component and visible only through the slot 3. Therefore, the contour of the washer 1 here is illustrated by dashed lines. However, the bore 6 in the washer 1 can be seen, which here is shaped as a short slot so that the latter can be covered across the full area by means of a round supplementary washer 5 (obscured by the component and the washer according to the invention, and indicated in chain-dotted lines in images A and B).

In image A, a screw 4 is situated at the uppermost end of the slot 3. Here, as also in the other images, the washer 1 covers the slot 3 across the full area. The bore 6 is covered across the full area by the round supplementary washer 5.

In image B, a screw 4 is situated in the upper half of the slot 3. For this purpose, the washer 1 does not necessarily have to be moved in comparison to image A, because the bore 6 still permits this position of the screw 4. In this position of the screw 4, the bore 6 is also covered across the full area by the round supplementary washer 5. This also applies to the following images in which the round supplementary washer 5 at all times covers the bore 6 but is no longer plotted therein.

In image C, a screw 4 is situated in the center of the slot 3. For this purpose, the washer 1 has to be displaced somewhat downward in order to cover the slot 3 across the full area.

In image D, a screw 4 is situated in the center of the slot 3. The washer 1 here, proceeding from image C, has been rotated by 180° about the screw 4.

In image E, a screw 4 is situated in the lower half of the slot 3. For this purpose, the washer 1 has been displaced downward somewhat.

In image F, a screw 4 is situated at the lowermost end of the slot 3. Here too, the washer 1 covers the slot 3 across the full area, as in image A but rotated by 180°.

It can be seen that in each position of the screw 4 in the slot 3 the latter can be covered across the full area by the washer 1.

FIG. 3 shows the dimensions of a preferred washer 1 having a disk body 1a and an elongate bore 6 in the disk body 1a. This bore 6 is disposed in the disk body 1a so as to be asymmetrical in terms of a rotation on the disk body about the center of the latter. Moreover, the bore 6 here is shaped as a slot with a length a and a width b, where a/b is approximately 1.4. The washer 1 per se is likewise shaped to elongate, wherein the ratio between the length L thereof and the width B thereof (L/B) equals 1.6.

The bore 6 lies substantially on one half of the washer 1 (indicated by dashed lines), but does not protrude into the other half by more than half of the width b of the bore, but only by approx. b/4, as can be seen. The longitudinal axis of the bore 6 (here the axis with the reference sign a) with the length a lies on the longitudinal axis of the washer 1 with the length L (solid line). As a result of the asymmetrical disposal of the bore 6, this results on the washer 1 in a shorter peripheral thickness with the length d and a shorter peripheral thickness with the length c, where c corresponds approximately to 2.1d. The inner periphery of the bore 6 (here the left periphery), which faces the longer peripheral thickness, with b>d has a spacing greater than (d−b)/2 from the center of the washer 1 (toward the left, because d−b<0). In this example, c≥a−b+2d applies to the length c of the longer peripheral thickness.

FIG. 4 and FIG. 5 show the coverage of a short slot 3 with round supplementary washers 5 according to the prior art. A standard supplementary washer 5 according to ISO 7089 is schematically illustrated on the left in FIG. 4, having an external diameter which corresponds to approximately twice the diameter of the bore. A standard supplementary washer 5 according to ISO 7093 is schematically illustrated on the right in FIG. 5, having an external diameter which corresponds to 3 times the diameter of the bore.

The supplementary washers 5 are indicated once by a solid line and once by a dashed line. These are the two outermost positions which the supplementary washers 5 can assume in order to completely cover the respective slot 3. For this purpose, the slot 3 on the left must not be longer than one and a half times the bore diameter b, and on the right must not be longer than twice the bore diameter b. In terms of the invention, the slot 3 is an elongate bore 6 in the washer 1 according to the invention.

FIG. 6 shows an example of a simple assembly module 7 in a perspective view. The assembly module 7 is preferably a metal construction and can be many times more complex than illustrated, for example it can be a metal tower or rail vehicle. The assembly module 7 as can be seen comprises at least one washer 1 according to the invention which preferably covers across the full area slot 3 of the assembly module 7 (therefore not visible). A method according to the invention is preferred for the construction.

It is finally pointed out once again that the washers and method described in detail above are merely exemplary embodiments of the invention that can be modified in many ways by the person skilled in the art without departing from the scope of the invention. Furthermore, the use of the indefinite article “a” does not preclude that the respective features may also be present in multiple. Likewise, the term “unit” also does not preclude that the respective components are composed of a plurality of interacting sub-components which optionally may also be spatially distributed.

1-10. (canceled)

11. A washer for covering a slot, the washer comprising:
a disk body and a bore formed in said disk body;
said bore being formed in said disk body so as to be asymmetrical in terms of a rotation on the disk body about a center of said disk body.

12. The washer according to claim 11, wherein:
said bore is an elongate hole with a length a and a width b, and wherein a>b;
said bore has a longitudinal axis with the length a and the width b lying on a longitudinal axis of the washer with a length L; and
as a result of the asymmetrical arrangement of said bore, the washer has a shorter peripheral thickness with a length d and a longer peripheral thickness with a length c along said longitudinal axis of the washer, and where c>1.5d.

13. The washer according to claim 12, wherein said bore is formed with semicircular end regions and a ratio a:b≤2.

14. The washer according to claim 12, wherein a ratio a:b≤1.5.

15. The washer according to claim 11, being an elongate washer with a length L of the washer being greater than a width B.

16. The washer according to claim 15, wherein a relationship between L and B is at least one of L>1.5B or L<3B.

17. The washer according to claim 11, wherein:
said disk body has a first half, a second half, and a center point, and said bore has a width b;
said bore lies substantially on the first half of the washer and said center point lies in said bore; and
a longitudinal extent of said bore does not protrude into said second half of the washer by more than one half of the width b of said bore.

18. The washer according to claim 11, wherein:
said disk body has a first half, a second half, and a center point;
said bore lies on the first half of said disk body by more than 70%, and part of an area of said bore protrudes into the second half;
said bore is positioned in the washer such that a center of a screw with an exact fit in said bore at each position in said bore lies beyond a center on said first half of the washer on which the greater area of said bore is situated.

19. The washer according to claim 12, wherein an inner periphery of said bore that faces the longer peripheral thickness c has a spacing of more than 0.4(d−b) and less than 0.6(d−b) from a center of the washer.

20. The washer according to claim 19, wherein the inner periphery has a spacing of (d−b)/2 from the center of the washer.

21. The washer according to claim 12, wherein a length c of the longer peripheral thickness is c≥a−b+2d.

22. A method for covering a slot in a component, the method comprising:
providing a washer according to claim 11;
placing the washer over the slot and introducing a cylindrical fastening element through the bore of the washer and through the slot;
aligning the fastening element in the slot at a predetermined fastening position;
aligning the washer to an overlapping position in which the slot is covered across an entire area and wherein, if an overlap with the slot is not possible in one alignment, rotating the washer by 180° about the fastening element; and
fastening the fastening element to clamp the washer in the overlapping position over the slot.

23. The method according to claim 22, wherein the bore of the washer is a slot, and the method further comprises additionally placing a supplementary washer over the bore of the washer in order to cover the bore of the washer across the entire area thereof.

24. The method according to claim 23, wherein the supplementary washer is a circular round washer.

25. An assembly module, comprising:
at least one washer according to claim 11 disposed to cover a slot of the assembly module across a full area thereof;
said at least one washer having been attached by:
placing the washer over the slot and introducing a cylindrical fastening element through the bore of the washer and through the slot of the assembly module;
aligning the fastening element in the slot at a predetermined fastening position;
aligning the washer to an overlapping position in which the slot is covered across an entire area and wherein, if an overlap with the slot is not possible in one alignment, rotating the washer by 180° about the fastening element; and
fastening the fastening element to clamp the washer in the overlapping position over the slot.

26. The assembly module according to claim 25, being a metal construction.

27. The assembly module according to claim 25, being a part of a rail vehicle.
